(19) United States
(12) Patent Application Publication
(10) Pub. No.: US 2003/0189413 A1
(43) Pub. Date: Oct. 9, 2003

(54) DC brushless motor having a control circuit

(76) Inventor: Hsin-Mao Hsieh, Pingtung City (TW)

Correspondence Address: BACON & THOMAS, PLLC, 625 SLATERS LANE, FOURTH FLOOR, ALEXANDRIA, VA, 22314

(21) Appl. No.: 10/115,521

(22) Filed: Apr. 5, 2002

(51) Int. Cl. H02P 1/18

(52) U.S. Cl. 318/254

(57) ABSTRACT

A brushless motor having a control circuit with a heat detector has a rotor, a stator with two coils and a control circuit. The control circuit has a driver IC connected to the two coils, a Hall element connected to the driver IC, a heat detector connected to driver IC and an AC to DC converter connected to an AC power source. The AC to DC converter provides converted DC power to the driver IC, the coils and the Hall element to make them operate normally. Therefore, the motor can directly use the AC power source by the control circuit. The motor has a function for automatically adjusting rotational speed of the motor by the heat detector to decrease power consumption.

### BACKGROUND OF THE INVENTION

1. Field of the Invention

The present invention relates to a DC brushless motor having a control circuit, and more particularly to a motor that has a control circuit having an AC to DC converter and a heat detector. The control circuit can make the motor normally operate in an AC power source by the AC to DC converter and automatically adjusts rotational speed of the motor by the heat detector.

2. Description of Related Art

Recently, DC brushless motors having small sizes are quite popular for driving cooling fans particularly in electronic equipment. With a Hall element, a conventional control circuit is able to detect phase changes of coils inside the motor so that the control circuit can provide a suitable signal to the driver IC to continuously drive the motor. The DC brushless motors use the DC power source to operate, and the DC motors only keep fixed rotational speed when the DC power inputs to the DC motors.

The DC motors are not directly connected to an AC power source to operate. Besides, the electronic equipment does not keep high heat during operating, so that the DC motors do not keep rotating to consume power.

To overcome the shortcomings, the present invention tends to provide an improved DC brushless motor having a control circuit to mitigate and obviate the aforementioned problems.

### SUMMARY OF THE INVENTION

The main objective of the invention is to provide a DC motor having a control circuit to enable use of an AC power source.

Another objective is that the motor having control circuit has a function for automatically adjusting rotational speed of the motor according the temperature change around the motor.

Another objective is that the motor having the control circuit has a function to output rotational speed of the motor.

Another objective is that the motor having the control circuit has a function to output lacked rotor signal of rotor of the motor when the rotor is interrupted abnormally to rotate.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a control circuit of a DC brushless motor in accordance with the present invention; and

FIG. 2 is a circuit diagram of a control circuit for a DC brushless motor in accordance with the present invention.

### DETAILED DESCRIPTION OF THE PREFERRED EMBODIMENT

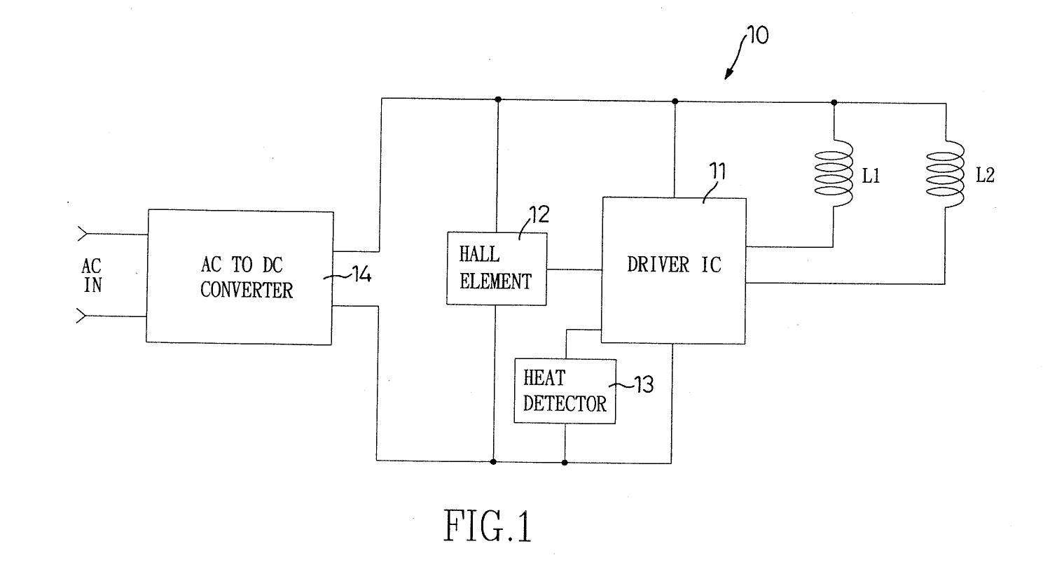

A DC brushless motor has a rotor, a stator with two coils and a control circuit connected to the two coils. With reference to FIG. 1, the control circuit (10) comprises a driver IC (11), a Hall element (12), a heat detector (13) and an AC to DC converter (14).

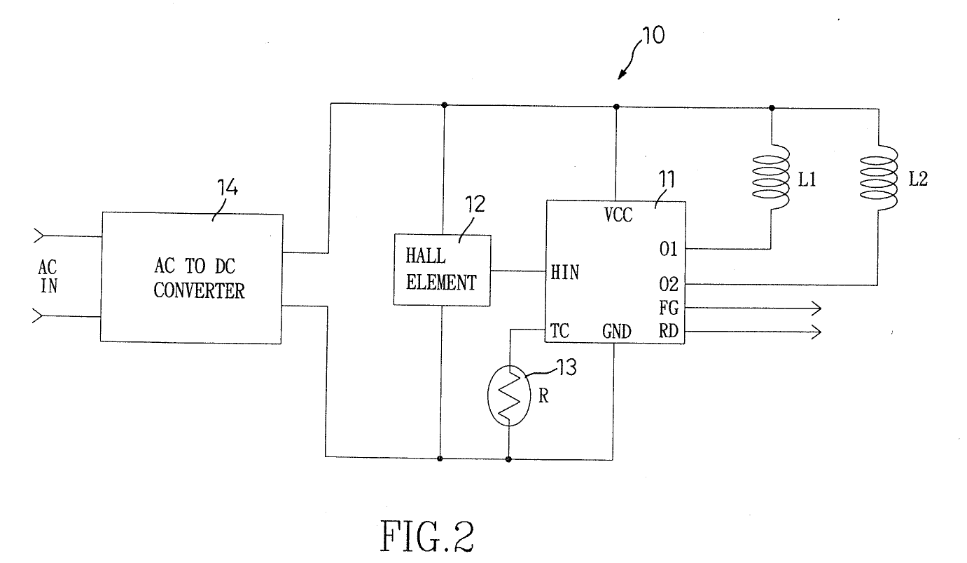

Referring to FIG. 2, the driver IC (11) comprises a Hall signal input terminal (HIN), two current output terminals (O1, O2), a temperature control input terminals (TC), two voltage input terminals (VCC, GND), a frequency generator output terminal (FG), and a rotor detector output terminal (RD). The two current output terminals (O1, O2) are connected to the two coils (L1, L2).

The Hall element (12) has one output terminal connected to the Hall signal input terminal (HIN) of the driver IC (11) and two voltage input terminals. The Hall element (12) detects phase changes in the two coils (L1, L2) of the motor (not shown) and then outputs a Hall signal to the driver IC (11).

The heat detector (13) is connected to the temperature control input terminal (TC) of the driver IC (11). The heat detector (13) can detect temperature change around the motor and then outputs an electronic signal having multiple amplitudes of voltage to the driver IC (11). The heat detector (13) is a thernoster (R).

The AC to DC converter (14) has two AC power input terminals and two DC power output terminals. The AC to DC converter (14) is connected to the two voltage input terminals (VCC, GND) of the driver IC (11), two voltage input terminals of the Hall element (12) and the two coils (L1, L2). The AC to DC converter (14) is connected to the AC power source to convert the AC power to a DC power. Therefore the AC to DC converter (14) provides the DC power to the driver IC (11), the Hall element (12) and the two coils (L1, L2). The coils (L1, L2) are connected to the AC to DC converter (14).

The AC to DC converter (14) converts the AC power to the DC power, so that the driver IC (11), the Hall element (12) and the coils (L1, L2) are able to operate normally. Therefore the motor with the present invention can be connected directly to the AC power source.

The resistance of thermoster (R) changes according the temperature, so that a voltage of the thermoster changes according to temperature, too. Therefore, after the driver IC (11) has received the changed voltage of the thermoster (R), the driver IC (11) adjusts the output current for the two coils (L1, L2). Therefore, rotational speed of the motor is controlled by the thermoster (R). Thus, the motor has lower power consumption during rotation than other motors.

The driver IC (11) has the frequency generator output terminal (FG), thus the rotational speed of the motor is detected easily from the frequency generator output terminal (FG). Besides, the driver IC (11) has the rotor detector output terminal (RD) to output a locked rotor signal from detecting whether the rotor (not shown) of the motor is locked by an outer force during operation of the rotor. Thus, the control circuit designer is able to further use the two output terminals (FG, RD) of the driver IC (11) to repair the motor easily. The control circuit for DC brushless motor in accordance with the present invention not only directly connects the AC power source, but also has other functions, such as automatic adjusting rotational speed, outputting rotational speed and detecting whether the rotor of the motor rotates normally.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A DC brushless motor having a control circuit, comprising a rotor, a stator with two coils and a control circuit, wherein the control circuit comprises:
a driver IC having a Hall signal input terminal, a temperature control input terminal, two voltage input terminals and two current output terminals respectively connected to the two coils to control operation of the coils;
a Hall element connected to the Hall signal input terminal to detect phase change in the two coils and then output a signal, wherein the Hall element has two voltage input terminals;
a heat detector connected to the temperature control input terminal to detect the temperature change around the motor;
an AC to DC converter connected to the two voltage input terminals of the driver IC, the two voltage input terminals of the Hall element, and the two coils to convert an AC power source to a DC power, wherein the DC power is provided to the driver IC, the Hall element and two coils to operate normally.

2. The DC brushless motor as claimed in claim 1, wherein the driver IC further comprises a frequency generator output terminal to output rotational speed of the motor.

3. The DC brushless motor as claimed in claim 2, wherein the driver IC further comprises a rotor detector output terminal to output a signal caused to detect whether the rotor rotate is locked by outer force.

4. The DC brushless motor as claimed in claim 2, wherein the heat detector is a thermoster.
